(19) United States
(12) Patent Application Publication
(10) Pub. No.: US 2007/0267903 A1
(43) Pub. Date: Nov. 22, 2007

(54) Barber or beauty chair: a chair for barbers or beauty salons which offers sitting for barbers while cutting hair.

(76) Inventor: Rexhep Hasimi, (US)

Correspondence Address: REXHEP HASIMI, 3412 - WEST MONTROSE AVE., # 107, CHICAGO, IL, 60618-1152, US

(21) Appl. No.: 11/383,599

(22) Filed: May 16, 2006

(51) Int. Cl. B60N 2/38

(52) U.S. Cl. 297/195.11

(57) ABSTRACT

There are very few professions out there that require the person to stand in order for him/her to perform the duties. Beauty profession has been around for ages and yet no one has proposed any new inventions to help barbers perform their job sitting down. I am proposing a new invention which will allow barbers to sit down while cutting hair. This new invention is designed for the barber and it can only be used by barbers and beauty salons. Having the experience of working at a barber shop for many years and I know how exhausting it is for a barber to stand for long hours. I stared to work on this new invention with the purpose of easing the barbers job by making it possible for the barber to sit while cutting hair.

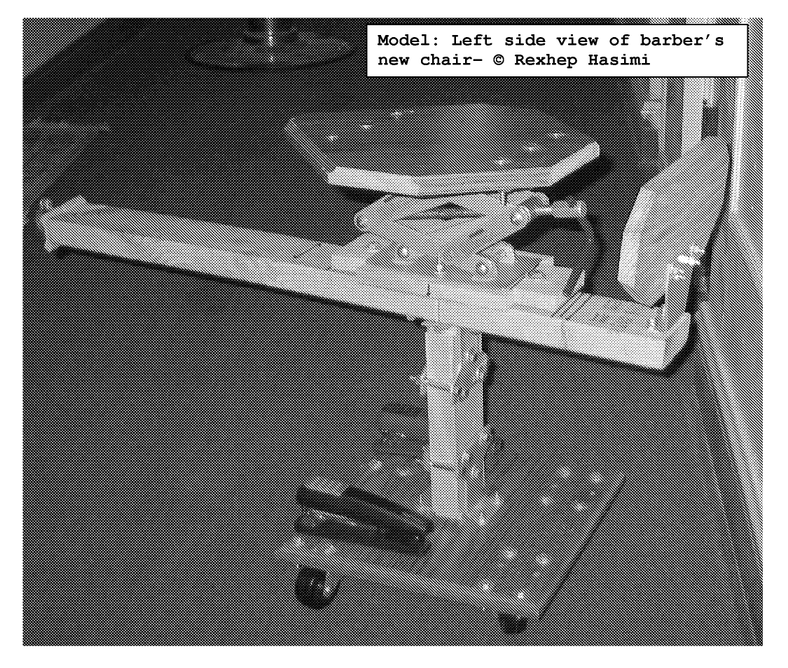

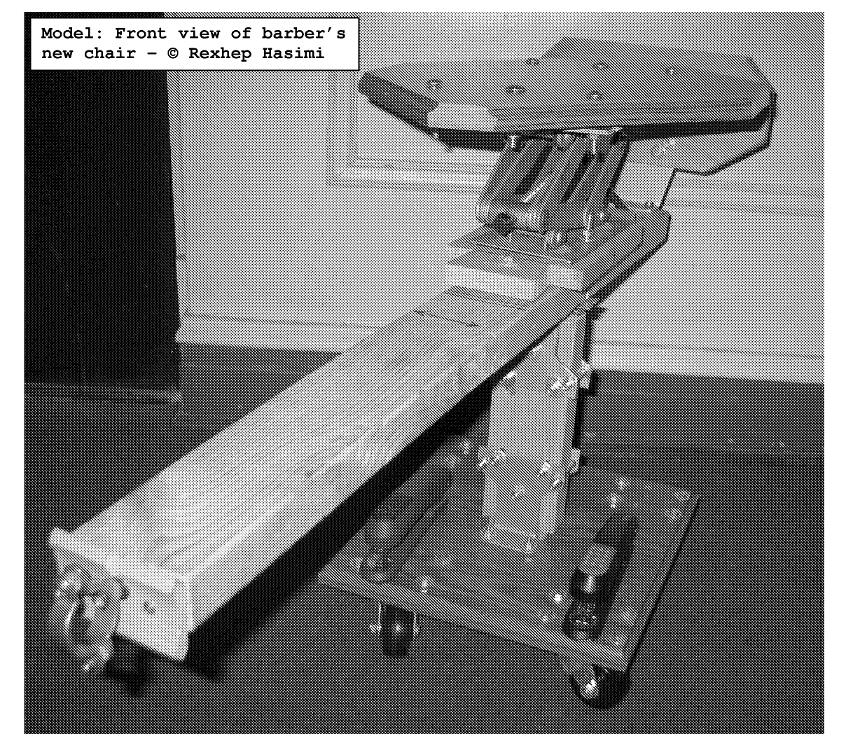

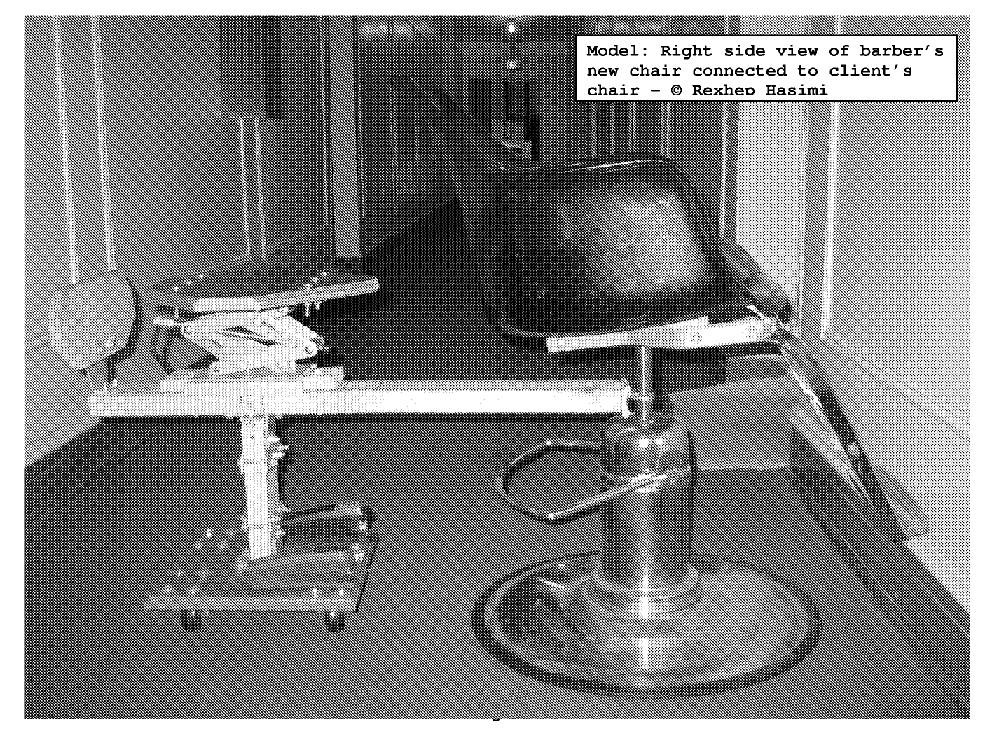

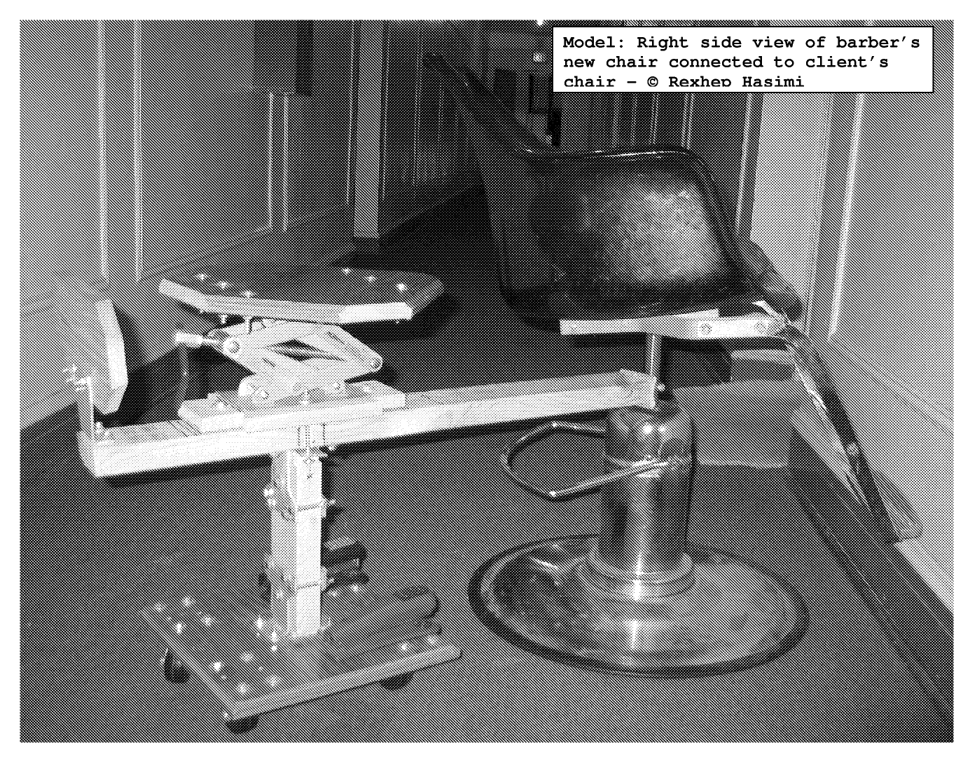

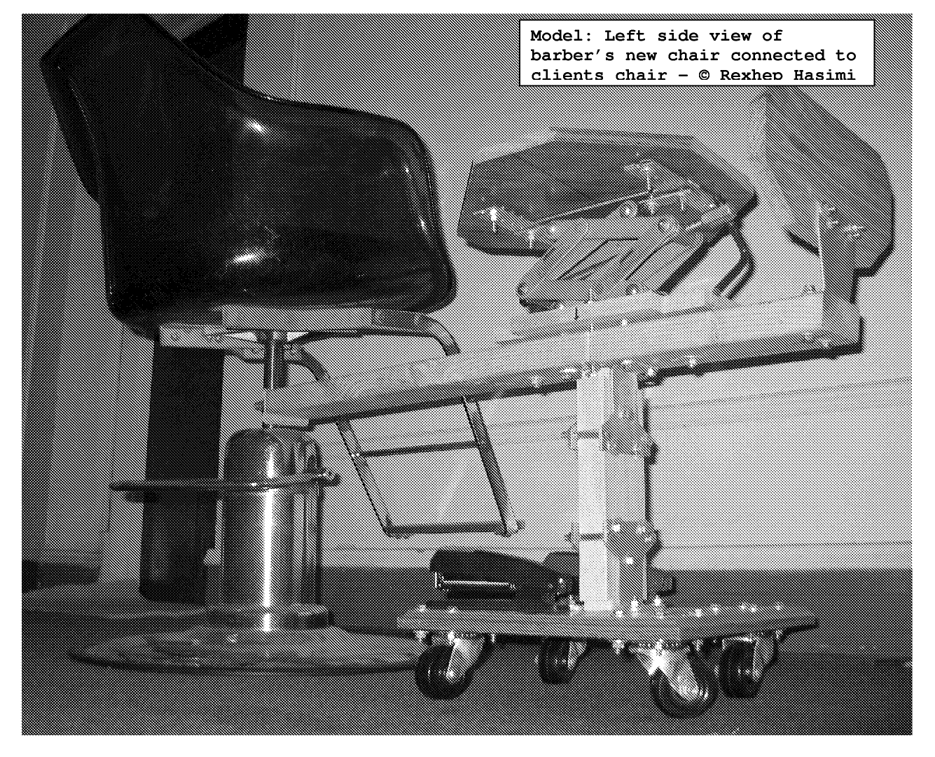

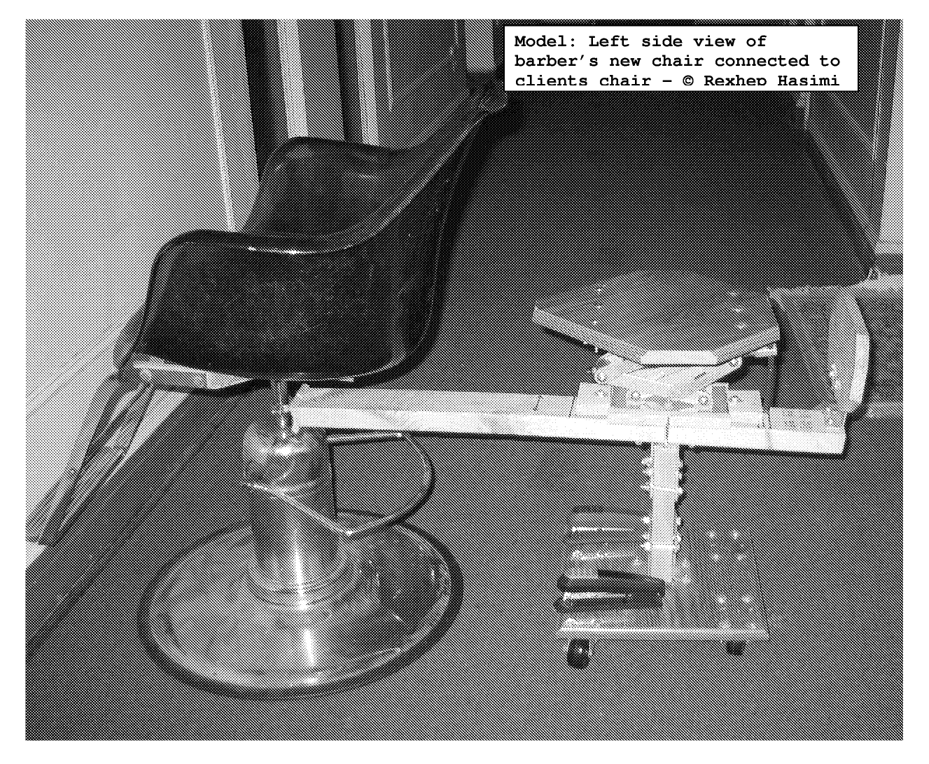

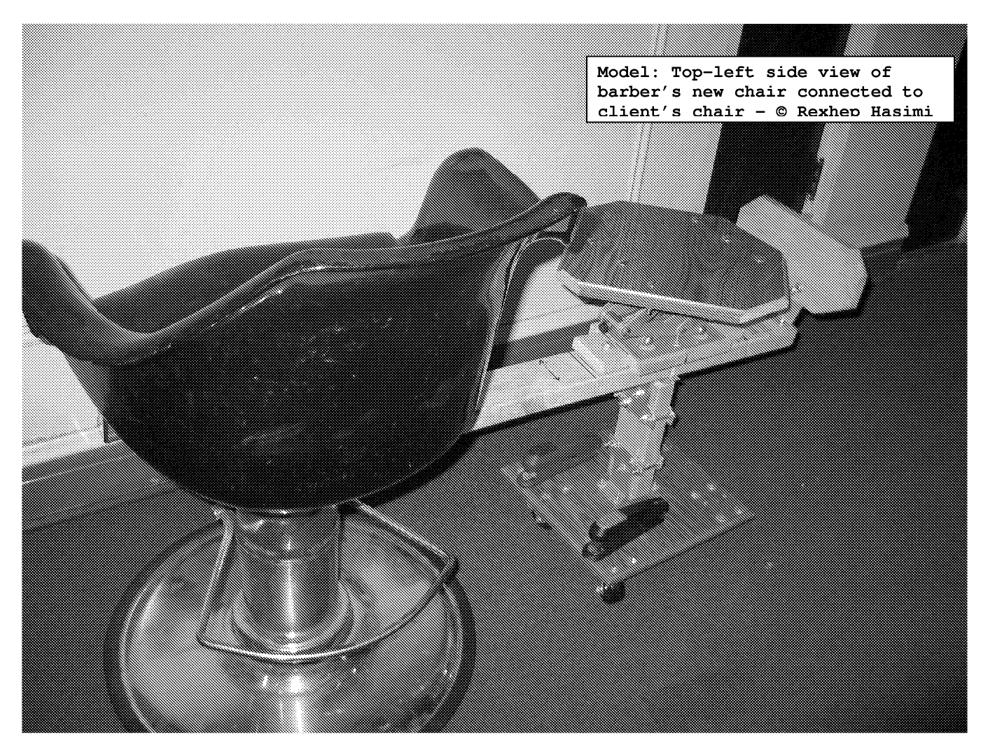

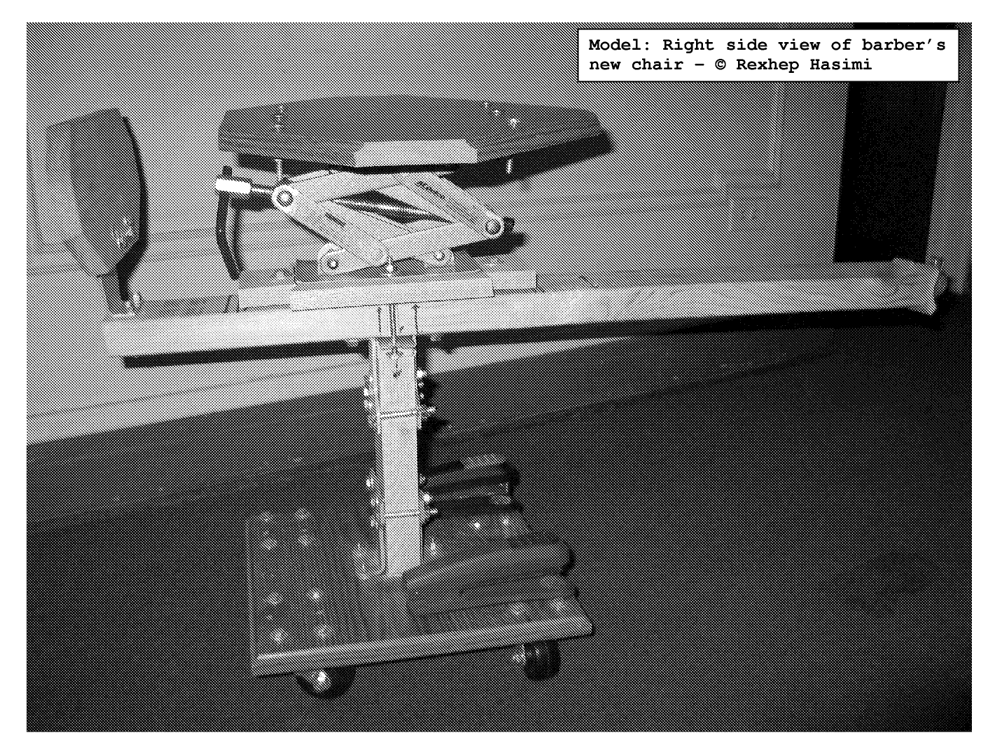

In beauty salons it is well known and massively used the clients chair is an essential tool for the barber and the clients. The idea I propose stands for a new modernized and improved barber chair. Throughout many modifications and ideas I preformed, I propose a different kind of barber chair that includes a place for the barber and the client to sit. Whether it's a male or female using this chair, the new chair would allow the barber to move around the client's chair freely and also give the option to the barber of sitting while cutting hair. The barber can choose to sit the whole time while cutting the clients hair without any complication towards the job being performed.

The new chair I propose has many elements similar to the dentist chair, medical chair, and different office chairs. In addition, its purpose has new elements in the mechanisms for the structure form since it is created for a new set purpose (which will be used by the barber to cut hair). In addition to the normal client chairs currently used by all barber shops and beauty salons, the new chair will consist of an additional seat slaved to the client's chair which the barber would be able to sit on. The height of the new chair is modified to match the height of the barber's profile view if he were to stand up. The new chair would allow the barber to move freely around the clients chair while sitting. The barber would be able to perform the same tasks sitting down in this new chair compared to standing (which is how barbers currently perform their job).

The new chair, which allows the barber to sit while performing his/her duties, is united with a bar across the middle to hold the clients chair together with the barber's new chair. This bar moves around the clients chair freely and allows the barber to change positions and move around the clients chair as needed. The barber's new chair is mounted with the client's current chair through a bar. The unity of the new chair I propose and the current client chair is essential because it will help the barbers move around freely and perform their duties much easier. If the chair was not united, it would be impossible for the barber to maneuver around the client's chair at a desirable distance, to easily perform his/her duties without loosing any time. In other words, the new chair would just simply be a stool to the barber if it was not mounted together with the barber's chair.

Having experience in barber shops, stools are useless when cutting hair. But the new chair I propose will be different and will serve the barber as a sitting place while cutting hair at the same time allowing all activities the barber used to do when he was standing up. Another reason why this new chair is just not another stool and why it requires bar mounting the client's chair with the new chair is the idea of motorization. To allow the barber to move freely around the client's chair, I also propose that this new chair, for the barber to sit on, to be motorized to allow moving around the client's chair and adjust its height. The mechanics, which will be worked on later to the model, will allow the barber to move the chair up or down (based on their desired height) and side ways. This is what sets this idea apart and its importance to the barber. (The idea is also described in a non-mechanized version which will serve the same purpose but the movements will be done by the barber's feet instead of a motor).

### Idea:

New Barber Beauty Chair—I have worked in barber shops for many years. I have done lots of research on this idea and I have not come across such a chair or idea. I am 100% certain that this idea, let alone the chair, is not in existence today. The idea of the barber sitting down while cutting hair is yet to be discovered due to the traditional barber chairs, which do not allow the barber to sit down while cutting hair. Other professions, like the dentist chair and other medical chairs, allow the doctors to sit down and perform their job while sitting. This is due to their design which allows doctors to adjust the chair based on their needs. I propose the same concept, which would allow the barber to sit down while cutting hair.

In my idea I propose that, like many professions, barbers should have a place to sit and freely perform their job duties while cutting hair. When the barber feels tired while working standing up, he/she can sit down to rest the feet while at the same time cutting hair. When he/she feels tired from working while sitting down, the chair I propose would allow them to work standing up. So the chair allows the barber to choose whether he/she would want to work standing up or sitting down.

My idea of this new chair mounted together with the client's chair is simple in detail. It consists of a bar uniting barber's chair with the client's chair (see C in schematics #1). This bar will serve as a bridge which will connect the two chairs and will make possible a new chair for the barber to sit on. This will be something new and will upgrade this old profession with new modernized equipment. This will make it possible for barbers all over the world to finally get a chance to sit while working.

Schematics 1 and 2, illustrate many familiar items which make up the new chair. Items such as the current barber chair, traditional bar, wheels, nuts, and powered motors are modified in different ways to make possible the new chair. In addition to schematic drawings of the new idea, I have also labeled and explained in further details what each item is and its purpose. I have also built a model of the idea and will provide pictures. Looking at the schematics carefully, there is a clear distinction between what I propose and what the barbers currently use (traditional barber chair).

The new Barber Beauty Chair is presented in two versions which both serve the same purpose but different designs and are different in ways which their purpose is delivered.

VERSION 1(schematic 1): Is somewhat simpler than version 2 and it is not motorized. Its movements are in a different form, which will be possible by the barber's foot pushing the chair left or right, while the barber is sitting down and cutting hair.

VERSION 2 (schematic 2): This version is somewhat sophisticated, which will include a silent motor. The motor will be at the base of the chair held by 5 wheels (see schematic 2: E, G). The motor will work with electricity which will function for the purpose of moving the new barber chair left or right around the client's chair. The new chair will also house two pedals which will allow the barber to move the chair left or right using his feet while sitting and cutting hair. The right pedal will allow the barber to move his chair which he is sitting to the right, while the left pedal will make possible the left movements using the left foot.

### Schematic 1, Non-Motorized Model—Detailed Description of the Drawings

A. Seat cushion for the barber to sit.
B. Tube that mounts with E and connects with C.
C. Bar that unites B with K, and this bar is the key idea of the invention which makes the idea of sitting possible.
D. The connection hinge which can move freely around the chair.
E. The main connection bar between the seat cusion of the barber and the bottom base of the chair.
G. Threaded bar made to fit with the base.
J. The bolt which connects E with the base.
L. Mechanical hand pedal which will make possible the raising or lowering of A (lowering and rising barber's seat).
N. The floor base of client's chair.
K & M. Barber's left foot (when moving the seat manually).
K & D. Barber's right foot (when moving the seat manually).
M. Hinge that will allow the moving of D left or right freely.
1-5. Five wheels that will hold the base up when meeting the floor.

### Schematic 2, Motorized Model—Detailed Description of the Drawings

A. Seat cushion for the barber to sit.
B. Tube that mounts with E and connects with C.
C. Bar that unites B with K, and this bar is the key idea of the invention which makes the idea of sitting possible.
D. The connection hinge which can move freely around the chair.
E. The main connection bar between the seat cushion of the barber and the bottom base of the chair.
G. Threaded bar made to fit with the base.
J. The bolt which connects E with the base.
L. Mechanical hand pedal which will make possible the raising or lowering of A (lowering and rising barber's seat).
N. The floor base of client's chair.
P & M. Left foot pedal.
P & D. Right foot pedal.
M. Hinge that will allow the moving of D left or right freely.
1-5. Five wheels which hold up the base and are powered by a motor to move left or right.

Barber Beauty Chair—I claim the idea as well as the model of a new barber chair which will be able to provide a seat for the barber and the client to sit on, while the barber cuts hair. This new idea will allow barber's to perform their duties around the salon while sitting down without any complications towards their performance.

What is claimed is:

1. The new chair—Is structured on six detailed objects which are currently found in the chairs used by dentists and doctors. Two different models are presented with the idea.
1. The base structure of the barber's chair that meets the ground floor, houses five wheels that are fixed to arc around the client's chair (see schematic 1 & 2).
2. The base structure of the barber's chair that meets the ground has two versions:
a. Schematic 1, barber's new chair will arc around the client's chair by the barber controlling the movement by feet.
b. Schematic 2, barber's new chair will arc around the client's chair by an electric motor, which can be controlled by the barber's feet from two designed foot pedals in the base of the structure where barber's feet will rest while sitting down and performing their duties.
3. In the middle of each of the two structures—one with an electrical motor and one without a motor—is an opening (schematic 1 & 2, G) which will house the bar for the sitting cushion. This will be able to move up or down based on the desired height by the barber.
4. In schematic 1 & 2, C, is showing a bar which will make possible the connection of the barber's new chair with the client's chair. This bar is the most important detail of the new invention because it will make possible the idea of connecting the two chairs together in order to make the chair easily maneuverable by the barber, while at the same time keeping the right distance from the client to perform the job freely. This bar will also be adjustable in terms of the distance between the client's chair and the barber's new chair. At the ends of this bar is a removable hinge (schematic 1 & 2, D). This removable hinge will serve the purpose of splitting the two chairs (as desired by the barber) and to move the chair freely sideways.
5. From my invention, the proposed idea of uniting the new barber chair with the traditional client chair will allow barber's all over the world to use this new chair for the purpose of sitting down and freely cutting hair. This idea will make it possible for barbers to finally sit while performing their duties with a type of chair specifically designed for them.
6. Elements that make up the new invention: (schematic 1 & 2)
a. A specific base which houses the 5 wheels that meet the floor.
b. A long tube that houses the seating cushion (and will be able to be adjusted in its height).
c. A seating cushion that can be adjusted in height.
d. A bar that runs across from the client's chair to the barber's new chair. This will make possible the joining of the two chairs which will be unique in the idea. It will allow the barber to freely perform his or her duties.
All other claims are specified in the schematic drawings and explanations. Also photos will be provided which will server for the purpose of the design model, idea, and specification.
